(19) United States
(12) Patent Application Publication
(10) Pub. No.: US 2012/0170728 A1
(43) Pub. Date: Jul. 5, 2012

(54) Voice-Enabling Kiosks with Mobile Devices

(75) Inventors: Michael S. Wengrovitz, Concord, MA (US); Jean-Pierre E. Albinet, Thousand Oaks, CA (US)

(73) Assignee: ALCATEL-LUCENT USA, INC., Murray Hill, NJ (US)

(21) Appl. No.: 12/984,147

(22) Filed: Jan. 4, 2011

(51) Int. Cl. H04M 11/00; G06F 3/041

(52) U.S. Cl. 379/93.21; 345/173

(57) ABSTRACT

A kiosk is voice-enabled using a mobile device of a customer. The kiosk receives customer identification information identifying the customer and determines conference call information based on the customer identification information. The conference call information enables a conference call to be established between a mobile device of the customer and a call center agent associated with the kiosk.

### BACKGROUND OF THE INVENTION

1. Technical Field of the Invention

The present invention relates in general to kiosk systems, and in particular, to providing voice communications with kiosk systems.

2. Description of Related Art

An interactive kiosk operates as a computer terminal that enables a customer to access information related to a business. Kiosks are typically found in high foot traffic areas to provide a convenient solution for customers to access various services provided by the business, such as banking, ticket purchasing and airport check-in. In certain situations, the customer may wish to initiate contact with a call center agent of the business to inquire about a particular service or problem that the customer is experiencing. For example, the customer may wish to speak with a representative of an airline about seat selection, frequent traveler mileage, fare change, etc. In other situations, a call center agent may wish to speak with the customer, for example to personally welcome a Platinum member.

However, most kiosks do not allow the customer to actually speak with an agent. The kiosks that do allow voice communication typically have telephone sets that are either built-in or wall-mounted adjacent to the kiosk. However, the kiosks with built-in telephone sets are awkward, and consume excessive countertop space. In addition, kiosks with built-in speakers cannot be heard in noisy environments, such as airline terminals. Moreover, with wall-mounted telephone sets, the kiosk must be located strategically against a nearby wall so that the wall-mounted set can be used as a hot-line to a call center providing voice assistance. Many people resist using such sets for health reasons to avoid the spread of cold and flu viruses when the set is handled and placed near the mouth and nose.

Therefore, what is needed is a method and system for simplifying the means by which a customer and call center agent can speak while the customer is using a kiosk.

### SUMMARY OF THE INVENTION

A kiosk associated with a business, in one embodiment of the present invention, enables a conference call to be established between a mobile device of a customer and an agent of a call center of the business. The kiosk includes a display, an input device and a processor. The input device receives customer identification information from the customer and the processor uses the customer identification information to determine conference call information for initiating a conference call between the customer's mobile device and the call center agent. The display displays at least a portion of conference call information to the customer.

For example, in an exemplary embodiment, the processor determines a mobile telephone number of the mobile device and displays the mobile telephone number to the customer as the portion of the conference call information. The kiosk may further include a graphical user interface that allows the customer to confirm, edit or enter the mobile telephone number of the mobile device. The graphical user interface may also include a touchscreen that displays one or more conference call icons that when selected by the customer establishes the conference call. The kiosk may further include a network interface coupled to a network to enable the processor to communicate with a kiosk server and instruct the kiosk server to establish the conference call.

In another exemplary embodiment, the conference call information displayed on the display includes a call center telephone number of the call center that the customer dials from the mobile device. The call center telephone number may be viable for a limited duration of time.

The input device may include one or more of the following: a touchscreen on the display, a barcode reader, a magnetic stripe reader, a keyboard, a keypad and a near field communication reader. In addition, the kiosk may be, for example, an automated teller machine (ATM), automated ticket machine or an airport kiosk. A kiosk server, in another embodiment of the present invention, is in communication with a plurality of kiosks of a business to facilitate establishing conference calls between mobile devices of customers and call center agents of the business. The kiosk server includes a network interface for receiving, via a network, customer identification information identifying a customer of the business from a kiosk of the plurality of kiosks. The kiosk server further includes a processor for determining conference call information based on the customer identification information, in which the conference call information enables a conference call to be established between a mobile device of the customer and a call center agent of the business.

In an exemplary embodiment, the conference call information includes a mobile telephone number of the mobile device and a call center telephone number of the call center, and the processor provides the mobile telephone number to the kiosk for display thereon while preventing the call center number from being provided to the kiosk for display thereon.

In yet another exemplary embodiment, the processor further provides the mobile telephone number and the call center telephone number to a conference bridge via the network interface to establish the conference call between the mobile device and the agent.

In still another exemplary embodiment, the processor uses the customer identification information to retrieve customer data, including the mobile telephone number, from an external database via the network interface and determines the conference call information from at least the customer data.

A system, in yet another embodiment of the present invention, enables a conference call to be established between a mobile device of a customer using a kiosk and a call center agent of a business. The system includes a kiosk server associated with a business, a conference bridge and a call routing system. The kiosk server receives from the customer, via a kiosk communicatively coupled to the kiosk server, customer identification information that identifies the customer. The kiosk server further determines conference call information based on the customer identification information, in which the conference call information includes a mobile telephone number of the customer's mobile device and a call center telephone number of a call center of the business. The conference bridge is coupled to the kiosk server via a network to receive the conference call information and operates to establish the conference call between the mobile device of the customer and the call center. The call routing system is within the call center and operates to determine the agent for the conference call and route the conference call to that agent.

In an exemplary embodiment, the conference bridge sets up a first leg of the conference call with the mobile device and subsequently sets up a second leg of the conference call with the call center. In yet a further exemplary embodiment, the call routing system further queries the kiosk server for call information related to the customer and/or the kiosk to determine the agent for the conference call. For example, the call information can include at least part of customer data determined by the kiosk server from the customer identification information.

A method, in still another embodiment of the present invention, voice-enables a kiosk with a mobile device. The method includes receiving at a kiosk server communicatively coupled to a kiosk, from a customer of the business via the kiosk, customer identification information that identifies the customer. The method further includes determining, by the kiosk server, conference call information based on the customer identification information, in which the conference call information includes a mobile telephone number of a mobile device of the customer and a call center telephone number of a call center of the business. The method still further includes providing the conference call information from the kiosk server to a conference bridge, establishing, by the conference bridge, a conference call between the mobile device of the customer and the call center and routing, by the call center, the conference call to an appropriate agent.

### BRIEF DESCRIPTION OF THE DRAWINGS

A more complete understanding of the present invention may be obtained by reference to the following detailed description when taken in conjunction with the accompanying drawings wherein:

FIG. 1 illustrates an exemplary voice-enabled kiosk using a mobile device of a kiosk customer, in accordance with embodiments of the present invention;

FIG. 2A illustrates an exemplary kiosk system that can provide voice communication services at kiosks, in accordance with embodiments of the present invention;

FIG. 2B illustrates an exemplary network for facilitating a conference call between a mobile device of a customer and a call center agent of a business, in accordance with embodiments of the present invention;

FIG. 3 is a flowchart illustrating an exemplary process for voice-enabling a kiosk with a mobile device, in accordance with embodiments of the present invention;

FIG. 4 is a block diagram illustrating exemplary components of an interactive kiosk, in accordance with embodiments of the present invention;

FIG. 5 is a block diagram illustrating exemplary components of a kiosk server, in accordance with embodiments of the present invention;

FIG. 6 is a block diagram illustrating exemplary components of a conference bridge, in accordance with embodiments of the present invention;

FIG. 7 is a block diagram illustrating exemplary components of a call center, in accordance with embodiments of the present invention; and

FIG. 8 is a flow diagram illustrating an exemplary process flow for facilitating a conference call between a mobile device of a kiosk customer and a call center agent, in accordance with embodiments of the present invention.

### DETAILED DESCRIPTION OF THE DRAWINGS

In accordance with embodiments of the present invention, kiosks are voice-enabled with mobile devices for improved customer experiences. The voice-enabled kiosk system is applicable to various kiosk scenarios including ATM banking, airport reservation/check-in and automated ticket machines used in train stations, theaters, and other facilities.

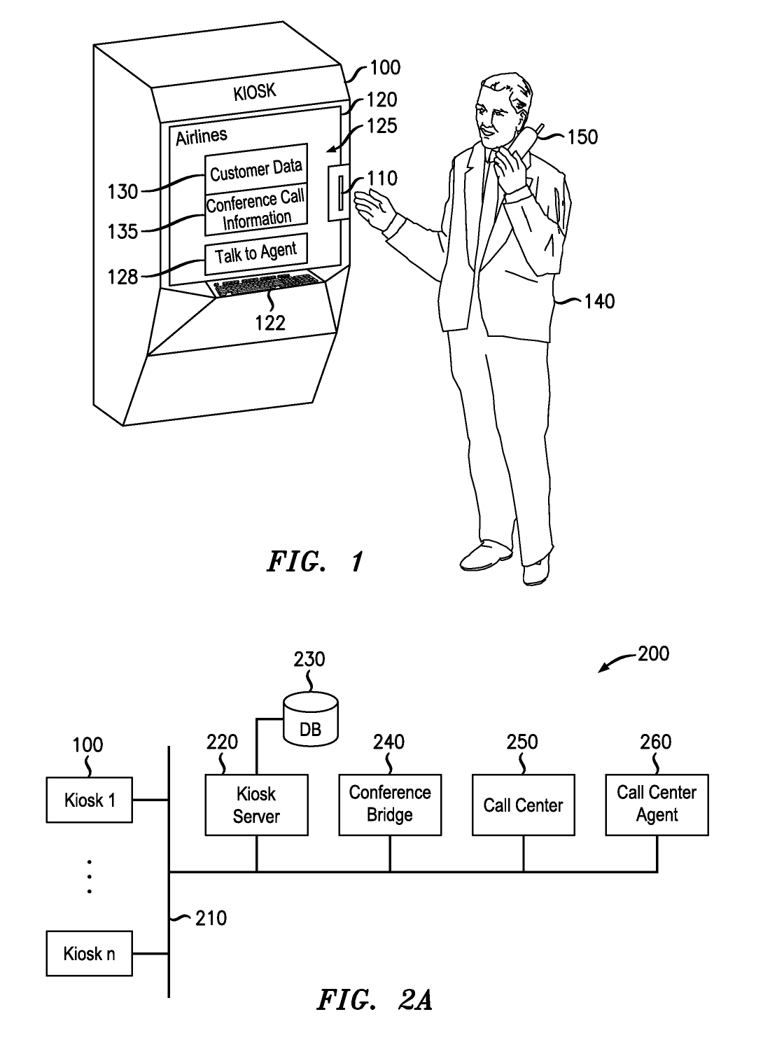

FIG. 1 illustrates an exemplary voice-enabled kiosk 100, in accordance with embodiments of the present invention. The kiosk 100 is typically associated with and operated by a business, such as an airline company, and enables a customer 140 of the business to quickly and conveniently access information and services provided by the business.

The kiosk 100 typically includes an input device 110 and a display 120. Examples of input devices include, but are not limited to, magnetic stripe readers, barcode readers, near field communication (NFC) readers (i.e., a Radio Frequency ID (RFID) readers), keyboards, keypads and touchscreens. The customer can enter customer identification information via the input device 110 to commence interaction with the kiosk 100. For example, the customer can swipe a credit card or other identification card in a magnetic card reader, scan a passport at a barcode reader, touch an RFID/NFC tag coupled to an ID card or a cellphone to an RFID/NFC reader or enter the customer identification information via a keyboard, keypad and/or touchscreen. In FIG. 1, the input device 110 shown is a magnetic stripe reader. However, other input devices are also shown in FIG. 1, such as a keyboard 122 and touchscreen 125. Therefore, it should be understood that the kiosk 100 may have multiple input devices, and is not limited to any particular one or combination of input devices.

Once the customer enters the customer identification information into the kiosk 100, the kiosk 100 can then look up customer data 130 based on the entered customer identification information and populate the customer data 130 on the display 120. The customer data 130 can include, for example, the customer's name, contact information for the customer (i.e., address and/or telephone number), account information, reservation information, customer's history (i.e., past transactions with the business) and any other information that may need to be displayed to the customer. The customer data 130 can be displayed in various levels, with general information being displayed on a first screen and more detailed information being displayed on another screen that is selectable from the first screen. For example, the general customer data 130 can include a “previous history” icon that when selected by the user brings up a list of previous transactions carried out between the customer and the business. As used herein, the term “screen” refers to the image (i.e., text, graphical features, background colors, etc.) displayed on a viewable area of the display 120 at a particular point in time.

In addition, the customer data 130 can further include at least a portion of conference call information 135 that enables a conference call to be established between the customer's mobile device 150 and a call center agent of the business. For example, the conference call information 135 displayed to the customer 140 may include the mobile telephone number of the customer's mobile device 150. The customer 140 can view the displayed mobile telephone number and confirm or edit the displayed mobile telephone number using, for example, the keyboard 122 or the touchscreen 125. In other embodiments, the customer can enter the customer's mobile telephone number directly into the kiosk 100 using, for example, the keyboard 122 or touchscreen 125.

The conference call information 135 may also include the call agent's telephone number, which is necessary to complete the conference call. However, in some embodiments, the call agent's telephone number may not be displayed to the customer, so as to prevent the customer from making later calls directly to the call center agent while the customer is not at the kiosk.

The touchscreen 125 further enables the customer 140 to interface with the kiosk 100 by touching icons displayed on the touchscreen 125. For example, if the customer 140 desires to speak to a call center agent while operating a kiosk, he/she can touch a conference call (or click-to-call) icon 128, such as the “Talk to Agent” icon shown in FIG. 1 on the kiosk touchscreen 125. Upon selecting the click-to-call icon, the kiosk 100 initiates a conference call between the customer's mobile device 150 and a call center agent. In an exemplary embodiment, after touching the “Talk to Agent” icon 128, the customer's mobile device 150 is called first (i.e., a first leg of the conference call is setup to the customer), and then once the customer 140 answers the call on the mobile device 150, a second leg of the call is immediately setup and routed to a suitable call agent. In this way, the customer can receive preferential routing, such that the customer need not wait in a log queue for the call center agent to answer the call.

In embodiments in which multiple levels of nested screens are presented to the customer, a different click-to-call icon 128 may be presented on each subsequent screen to route the customer to the appropriate call center agent to assist the customer with the information displayed on that screen. In addition, multiple click-to-call icons 128 can be displayed on the same screen, so that the customer can be directed to the appropriate call center agent for each item displayed on the screen. For example, one click-to-call icon 128 may initiate a call between the customer's mobile device 150 and an airline reservation department, whereas another click-to-call icon may initiate a call to a frequent flyer department. After the call is setup, the customer may also interact with an IVR and depress DTMF keys in order to be suitably routed to a call center agent.

It should be understood that the agents associated with the various icons may be at the same call center or at different call centers. Moreover, multiple agents may be associated with each icon and the conference call can be routed to one of the agents using any type of routing algorithm.

In another embodiment, the conference call can be initiated by the business to offer assistance to the customer 140. For example, upon receiving the customer data 130 and confirmation of the mobile telephone number of the customer's mobile device, the customer's mobile device 150 and a call center agent can each be called to join them together in a conference call. In this embodiment, the customer 140 would not need to touch the click-to-call icon 128 to initiate the call, but rather the call would be automatically established once the customer data 130 and conference call information 135 is ascertained.

In other embodiments, instead of displaying the mobile telephone number of the customer's mobile device 150 as the portion of the conference call information 135, a telephone number for a call center can be displayed to the customer 140. The customer can then dial the call center telephone number on the customer's mobile device 150 to speak to a call center agent. The call center telephone number can be specific to the screen that the customer is currently viewing to enable the customer to be routed to the appropriate call center agent, thereby receiving preferential call treatment.

In addition, to prevent the customer from receiving preferential call treatment while not at the kiosk, the call center telephone number may only be viable (i.e., a working number) for a limited duration of time. After the viable time period expires, the customer would no longer be able to reach a call center agent using the displayed call center agent telephone number. In another embodiment, instead of limiting the life span of the telephone number itself, a short life span access code can be provided to the customer. For example, the customer can dial the call center agent telephone number displayed on the screen and then enter the access code also displayed on the screen to be routed to an appropriate call center agent if the customer places the call prior to the expiration of the access code. After a predetermined period of time, the access code would expire, and the customer 140 would no longer be able to be connected to the call center agent using the access code. The customer would then be directed to a call center agent in the normal manner that customers are routed to call center agents by the business.

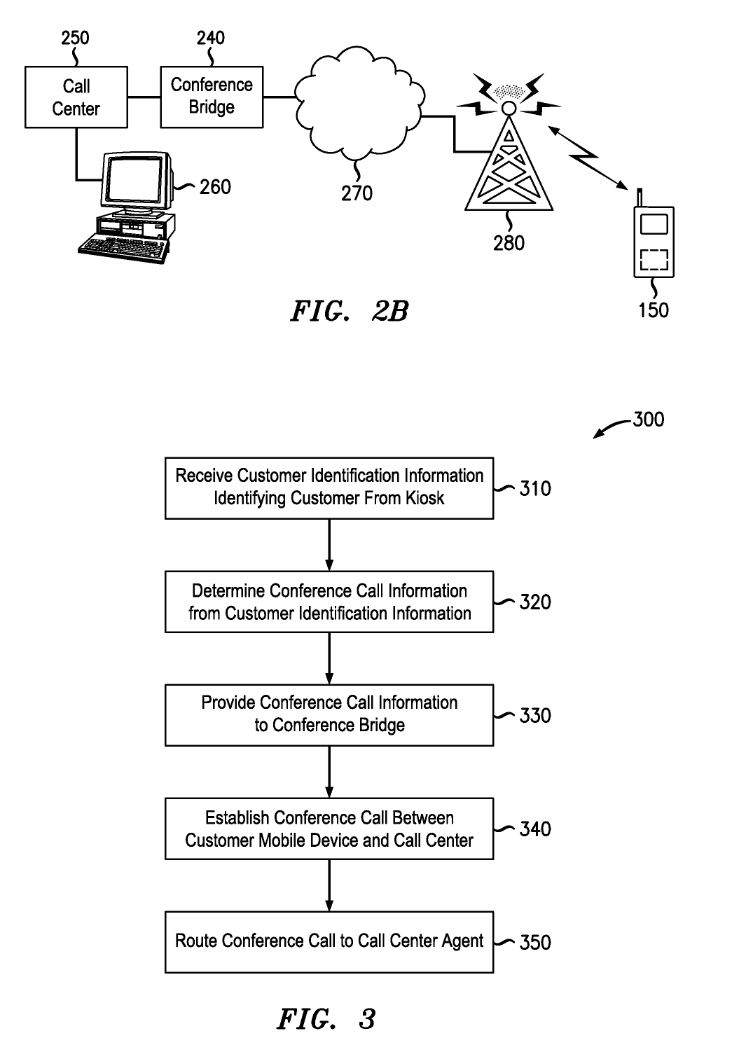

Turning now to FIG. 2A, there is illustrated an exemplary kiosk system 200 for providing voice communication services at kiosks 100 using customer mobile devices. The kiosk system 200 includes a kiosk server 220 coupled via a communication network 210 to a plurality of kiosks 100 (Kiosk 1 . . . Kiosk N). The communication network 210 may include, by way of example but not limitation, one or more of a local area network (LAN), a wide area network (WAN), a privately managed Internet Protocol (IP) data network, an Internet-based virtual private network (VPN), a public Internet-based IP data network or a circuit-switched network, such as the Public Switched Telephone Network (PSTN).

The kiosk server 220 is further coupled to a conference bridge 240 and at least one call center 250 having at least one call center agent 260 via the communication network 210. The conference bridge may be, for example, a Private Branch Exchange (PBX) with Computer Telephony Integration (CTI) or a separate conferencing bridge, such as Alcatel-Lucent's MyTeamwork™, which operates with any PBX or without a PBX. In addition, the call center 250 may also be, for example, a PBX or other call routing device. In some embodiments, the conference bridge 240 may be included within the call center 250. The call center agent 260 represents a communication device on which a call center employee may communicate with the customer. For example, the call center agent 260 may include one or more of a PBX or desktop phone, a mobile phone, a personal computer, a laptop computer, a hands-free headset and any other device that can be utilized to communicate with the customer. In one embodiment, the call center agent 260 is the call center 250 (i.e., the call center is a communication device). For example, the call center telephone number may be a direct telephone number to a particular call center agent 260.

In an exemplary operation, the kiosk server 220 is in communication with the kiosks 100 to receive customer identification information entered by customers into the kiosks 100. In response to receiving customer identification information from a kiosk 100, the kiosk server 220 retrieves customer data associated with the customer identification information from an internal or external database 230 (the latter being illustrated). For example, the kiosk server 220 can use the customer identification information as a pointer into the database 230 to retrieve the customer data. The customer data can include, for example, a mobile telephone number of a mobile device associated with the customer.

The kiosk server 220 further provides the retrieved customer data back to the kiosk 100 for display thereon to the customer. The customer can enter, edit and/or confirm the mobile telephone number of the customer's mobile device on the kiosk 100, which then provides the entered, edited and/or confirmed mobile telephone number to the kiosk server 220 for subsequent use and/or storage therein and/or within the database 230. The entered, edited and/or confirmed mobile telephone number can be transmitted to the kiosk server 220 immediately after receipt thereof or with an instruction to set-up a conference call between the customer's mobile device and a call center agent 260. For example, in one embodiment, the kiosk 100 can send the customer's mobile telephone number to the kiosk server 220 immediately upon receipt, and the kiosk server 220 can store the customer's mobile telephone number for subsequent use if the customer requests a conference call with a call center agent 260. In another embodiment, the kiosk 100 can store the customer's mobile telephone number and when the customer requests a conference call with a call center agent 260 (e.g., by touching a conference call icon on the kiosk touchscreen), the kiosk 100 can transmit the customer's mobile telephone number with an instruction to initiate the conference call to the kiosk server 220.

In other embodiments, the kiosk server 220 can use the customer data to identify the customer as a VIP and automatically initiate a conference call between the customer's mobile device and a call center agent without requiring the customer to request the call. In still other embodiments, the kiosk server 220 can use the customer data and kiosk information (i.e., information regarding the screen that the user is viewing, location of kiosk, type of kiosk, etc.) to determine the call center telephone number and, in some embodiments, an access code and provide that to the kiosk for display to the customer to enable the customer to dial the call center directly. The call center telephone number and/or access code could have a limited lifespan, thereby preventing the customer from receiving preferential call treatment while not at the kiosk 100.

In general, the call center telephone number could be a predetermined telephone number for all conference call requests or a specific telephone number determined based on the type of assistance that the customer needs. For example, the call center number could be determined based on the screen that the customer is currently viewing and/or the particular conference call icon that the customer touches. The kiosk server 220 identifies the correct call center telephone number by accessing the database 230 or via internal look-up.

In exemplary embodiments, the call center telephone number enables the conference call to be quickly and efficiently set-up without requiring the customer to navigate through an IVR system, thereby providing the customer with preferential call treatment. For example, a call routing algorithm executed by the call center 250 may be optimized when receiving a call at the call center telephone number so that the call is quickly set-up to an appropriate call center agent 260. In this embodiment, call information related to at least one of the customer and the kiosk 100 may be provided to the call center 250 to enable the call center 250 to determine the appropriate call center agent 260. The call information can include, for example, at least a portion of the customer data and other information provided by the kiosk server 220. Examples of call information include, but are not limited to, the location of the kiosk 100, the reservation data, the screen currently being touched, the customer's VIP status and other information that may assist the call center 250 in identifying the appropriate call center agent 260. In addition, the call information may also be passed from the kiosk server 220 or call center 250 to the call center agent 260 to enhance the customer experience and assist the call center agent 260 in handling the conference call.

In other embodiments, the call center telephone number is the main telephone number for the call center 250, which may require the customer to interact with an IVR system or operator or depress DTMF keys to reach the appropriate call center agent 260. For example, the customer may be directed to select from a menu of options, provide voice input or enter an access code or directory number to be routed to the appropriate call center agent 260.

To initiate the conference call, the kiosk server 220 first determines the call center telephone number and customer's mobile telephone number and then transmits an Application Program Interface (API) command to the conference bridge 240 instructing the conference bridge 240 to set-up a conference call between the customer's mobile device and the call center 250. The conference bridge 240 establishes the conference call between the customer's mobile device and the call center 250, which then routes the call to the appropriate call center agent 260. In an exemplary embodiment, the conference bridge 240 first calls the customer's mobile device to set-up a first leg of the conference call and then calls the call center 250 to set-up a second leg of the conference call. The two legs of the call are then bridged together at the conference bridge 240 and voice can be transmitted between the customer and the call center agent 260.

For example, with reference now to FIG. 2B, an exemplary network is shown for facilitating a conference call between a mobile device 150 of a customer and a call center agent 260 of a business, in accordance with embodiments of the present invention. As can be seen in FIG. 2B, the conference bridge 240 is coupled to both the call center 250 via, for example, a local area network, and to the mobile device 150 via an external communication network 270, such as the Public Switched Telephone Network (PSTN). Thus, the telephony connections for exchanging media between the call center agent 260, the mobile device 150 and the conference bridge 240 can utilize packet-switched connections, such as Voice over Internet Protocol (VoIP), e.g., Session Initiation Protocol (SIP), and/or circuit-switched connections, such as Integrated Services Digital Network (ISDN), e.g., Primary Rate Interface (PRI) trunks. For example, the conference server 100 can exchange SIP commands and VoIP Real Time Protocol (RTP) media with an external SIP-to-PSTN gateway, SIP phones, and other SIP devices. The conference server 100 can also incorporate, or interface to, an internal or external T1/E1 telephone trunk card for the exchange of voice signaling and media via the Public Switched Telephone Network (PSTN) with conventional POTS, PBX, and cell phones.

In an exemplary operation, the conference bridge 240 establishes each leg of the conference call by separately calling both the mobile device 150 and the call center 250. The mobile device leg of the conference call is routed through the external communication network 270 to a base station or wireless access point 280 currently serving the customer's mobile device. Once the mobile device 150 “answers” the call, the conference bridge 240 sets-up the call center leg of the conference call, and the call center 250 then routes the call to the appropriate call center agent 260, as described above.

FIG. 3 is a flowchart illustrating an exemplary process 300 for voice-enabling a kiosk with a mobile device, in accordance with embodiments of the present invention. The process begins at block 310, where a kiosk server receives from a kiosk communicatively coupled to the kiosk server customer identification information that identifies a customer currently interacting with the kiosk. At block 320, the kiosk server determines conference call information based on the customer identification information, in which the conference call information includes a mobile telephone number of a mobile device of the customer and a call center telephone number of a call center of the business. At block 330, the kiosk server provides the conference call information to a conference bridge, and at block 340, the conference bridge establishes a conference call between the mobile device of the customer and the call center. Finally, at block 350, the call center routes, the conference call to an appropriate agent. Voice can then be exchanged between the customer and the call center agent.

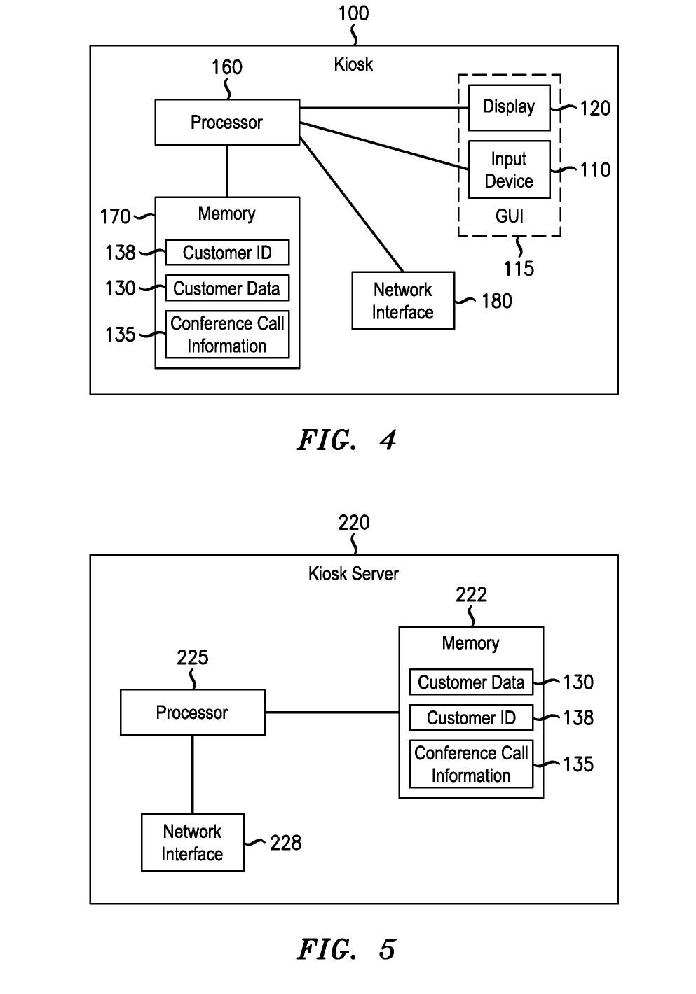

A more detailed view of exemplary components of the kiosk, kiosk server, conference bridge and call center can be found with reference to FIGS. 4-8. Turning now to FIG. 4, there is illustrated a block diagram of various exemplary components of the kiosk 100, in accordance with embodiments of the present invention. As shown in FIG. 4, the kiosk 100 includes an input device 110, display 120, processor 160, memory 170 and network interface 180.

The input device may include, for example, one or more of a magnetic stripe reader, barcode reader, near field communication (NFC) reader (i.e., RFID reader), keyboard, keypad, touchscreen or any other device that a user/customer may utilize to enter information into the kiosk 100. In some embodiments, the input device 110 and display 120 collectively provide a graphical user interface (GUI) 115 that enables the customer to interact with the kiosk 100 through manipulation of graphical elements displayed on the display 120.

The network interface 180 is coupled to a network to transmit and receive information to and from the kiosk server. For example, the network interface 180 can transmit customer identification information 138 and/or at least a portion of conference call information 135, such as the customer's mobile telephone number, to the kiosk server. As another example, the network interface may receive customer data 130, which can include at least a portion of the conference call information 135 (e.g., the customer's mobile telephone number), from the kiosk server. As shown in FIG. 4, the memory 170 may store the customer data 130, conference call information 135 and customer identification information 138.

The processor 160 includes one or more processors that are capable of executing one or more applications or programs, which may be stored in memory 170, to interface with the customer via the GUI 115, transmit and receive information to and from the kiosk server via the network interface 180 and store various data (i.e., customer data 130, conference call information 135 and customer identification information 138) within memory 170. As used herein, the term “processor” is generally understood to be a device that drives a general-purpose computer, such as a PC. It is noted, however, that other processing devices, such as microcontrollers, Field Programmable Gate Arrays (FPGAs), Application Specific Integrated Circuits (ASICs), or a combination thereof, can be used as well to achieve the benefits and advantages described herein. As also used herein, the term “memory” may include any type of data storage device, including but not limited to, a hard drive, random access memory (RAM), read only memory (ROM), flash memory, compact disc, floppy disc, ZIP® drive, tape drive, database or other type of storage device or storage medium. As further used herein, the term “network interface” refers to the point of interconnection between a device and a private or public network. A network interface is generally understood to be a network interface card (NIC), but in other embodiments, the network interface can be implemented in software

FIG. 5 illustrates exemplary components of the kiosk server 220, in accordance with embodiments of the present invention. As shown in FIG. 5, the kiosk server 220 includes a processor 225, memory 222 and network interface 228. The network interface 228 is coupled to a network to transmit and receive information to and from kiosks and a conference bridge. For example, the network interface 228 can receive customer identification information 138 and/or at least a portion of conference call information 135, such as the customer's mobile telephone number, from a kiosk. As another example, the network interface 228 may transmit customer data 130, which can include at least a portion of the conference call information 135 (e.g., the customer's mobile telephone number and/or call center telephone number), to the kiosk. As yet another example, the network interface 228 can receive an instruction from the kiosk to establish a conference call with the customer's mobile telephone device from the kiosk and can transmit an API command to the conference bridge to initiate the conference call.

The memory 222 may store the customer data 130, conference call information 135 and customer identification information 138 for use by the processor 225 while executing one or more applications or programs to transmit and receive information to and from kiosks via the network interface 228 and transmit conference call commands to the conference bridge via the network interface 228. The processor 225 may also use the customer data 130 to identify a VIP customer and automatically initiate a conference call between the customer's mobile device and call center agent.

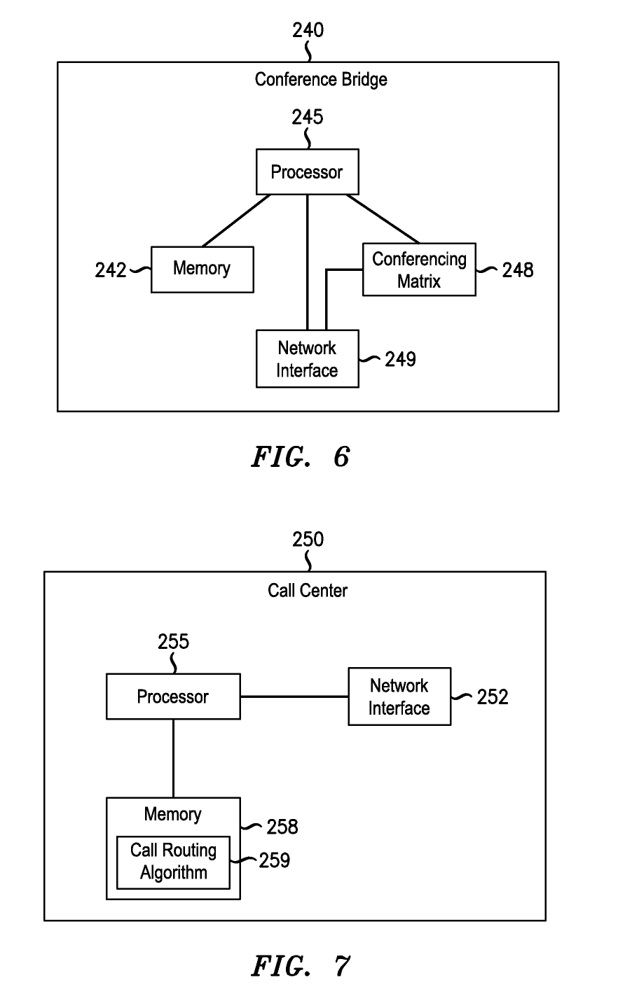

FIG. 6 illustrates exemplary components of the conference bridge 240, in accordance with embodiments of the present invention. As shown in FIG. 6, the conference bridge 240 includes a processor 245, memory 242, conferencing matrix 248 and network interface 249. The processor 245 includes one or more processors that are capable of executing one or more applications or programs, which may be stored in memory 242, to receive a command from a kiosk server to initiate a conference call between a customer's mobile device and a call center, to set-up each leg of the conference call and to bridge the two legs together to route voice and/or data between the customer's mobile device and the call center.

The network interface 249 may include one or more network interfaces to establish conference calls between customer's mobile devices and call centers. For example, the network interface 249 may include an IP network interface connected to a local area network transmit and receive control information to and from the kiosk server and to transmit and receive control information and media (e.g., VoIP media/voice streams) to and from the call center. In addition, the network interface 249 may include a telephony interface connected to an external network to transmit and receive media (e.g., circuit-switched voice, VoIP media/voice streams and/or data) to and from the customer's mobile device. As described above, the telephony interface can includes one or more of a packet-switched I/F for transmitting VoIP media, or a circuit-switched I/F for transmitting circuit-switched voice.

The conferencing matrix 248 may include a combination of specialized conferencing hardware or circuitry, software and/or firmware. In embodiments in which the conferencing matrix 248 is formed of software, the processor 245 may execute conferencing software routines to create virtual conference rooms within the memory 242 for the conference call. The conferencing matrix 248 establishes the different conference legs to/from each of the conference participants (customer's mobile device and call center) for the conference call and for manages the state of each the conference legs. For example, the conferencing matrix 248 can establish a respective conference leg for each voice and data connection to the conference call, add additional voice and/or data conference legs to the conference call, drop one or more voice and/or data conference legs and mute or un-mute one or more of the voice conference legs.

In a general operation of the conference bridge 240, the processor 245 accesses the conferencing matrix 248 to initiate and control a conference call between the customer's mobile device and the call center. For example, the processor 245 is operable to receive instructions for initiating and managing a conference call from the kiosk server via the network interface 249 and to cause the conferencing matrix 248 to set-up the conference call. Once the conference call is established, the conferencing matrix 248 receives incoming media (e.g., circuit-switched voice, VoIP media streams and/or data) from the conference participants via network interface 249, processes the received media using the processor 245 and transmits the processed media (e.g., mixed voice and/or data) back out to the conference participants during the conference call.

FIG. 7 illustrates exemplary components of the call center 250, in accordance with embodiments of the present invention. As shown in FIG. 7, the call center 250 includes a processor 255, memory 258 and network interface 252. The network interface 252 is coupled to a network to receive a conference call set-up request from the conference bridge and to receive from the kiosk server call information related to at least one of the customer and kiosk (e.g., location of kiosk, reservation data, customer's VIP status, type of assistance the customer is requesting, etc.). The network interface 252 is further coupled to the network to route the conference call to an appropriate call center agent.

The memory 258 maintains a call routing algorithm 259 that is executable by the processor 255 to determine the appropriate call center agent to route the conference call to. For example, the call routing algorithm 259 may utilize the call information provided by the kiosk server to determine the appropriate call center agent. As another example, the call routing algorithm 259 may utilize agent availability information to route the conference call to the next available call center agent. As yet a further example, the call routing algorithm 259 may determine a particular call center agent based on the type of assistance the customer desires or based on the customer's VIP status.

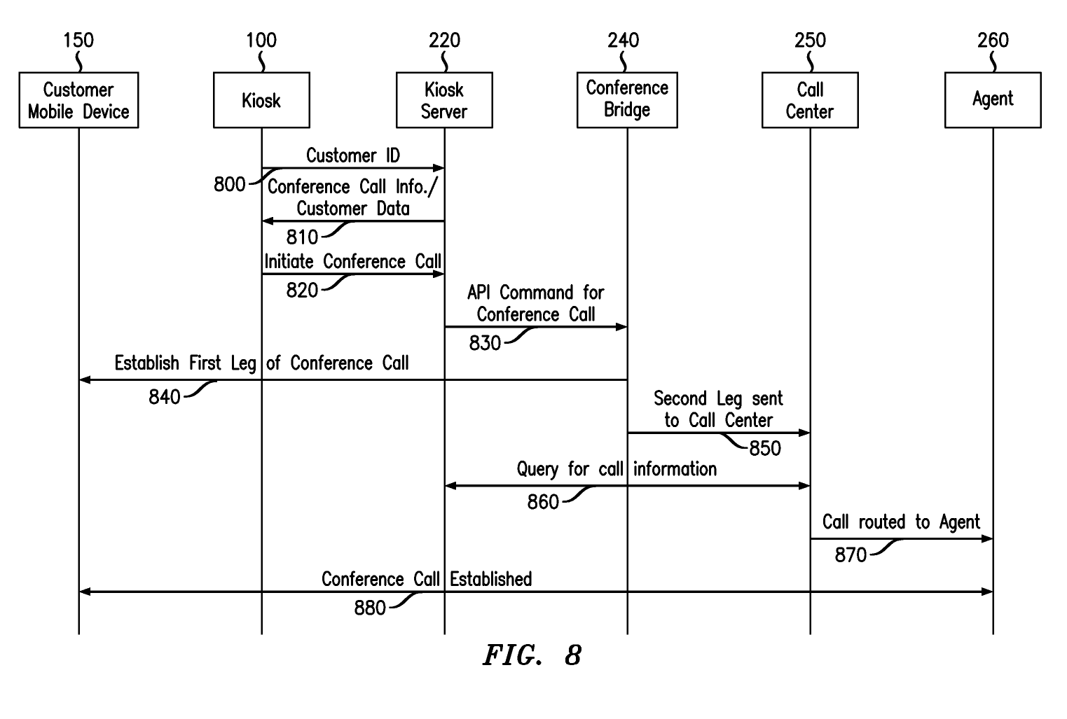

FIG. 8 illustrates an exemplary flow diagram for facilitating a conference call between a mobile device of a kiosk customer and a call center agent, in accordance with embodiments of the present invention. At 800, a customer steps-up to a kiosk 100 and enters his/her customer identification information into the kiosk, which is transmitted to the kiosk server 220. For example, the customer can swipe a credit card, scan a passport or touch an RFID/NFC cellphone to the kiosk 100. At 810, based on the customer identification information, the kiosk server 220 retrieves and transmits customer data, which may include at least a portion of conference call information (i.e., the telephone number of the customer's mobile device 150), back to the kiosk 100. The kiosk screen is then populated with the customer data, which may be edited by the customer on the screen.

The customer can progress through various kiosk screens, and at some point, may wish to talk to a customer service agent. If voice assistance is desired, the customer touches a click-to-call button on the screen, which, at 810, causes the kiosk 100 to transmit a request to initiate a conference call to the kiosk server 220. The kiosk server 220 then issues a two-party click-to-call API command to the conference bridge 240 at 830. The conference bridge 240 dials the customer's mobile device 150 at 840 to establish the first leg of the conference call. After the customer answers the call, the conference bridge 240 sets-up the second leg of the conference call to the call center 250 at 850. At 860, the call center 250 may optionally query the kiosk server 220 for additional information, such as kiosk location, customer VIP status, etc., as part of its algorithm to select the call center agent to which the second voice leg should be routed. At 870, the call center 250 routes the second leg of the conference call to the selected call center agent, and then at 880, the two legs are bridged together in the conference bridge 240, and the customer's mobile device 150 and call center agent 260 can exchange voice and/or data via the conference call.

As will be recognized by those skilled in the art, the innovative concepts described in the present application can be modified and varied over a wide range of applications. Accordingly, the scope of patents subject matter should not be limited to any of the specific exemplary teachings discussed, but is instead defined by the following claims.

We claim:

1. A kiosk associated with a business, comprising:
a display for displaying at least a portion of conference call information to a customer of the business, the conference call information enabling a conference call to be established between a mobile device of the customer and an agent of a call center of the business;
an input device for receiving, from the customer, customer identification information that identifies the customer; and
a processor coupled to the input device to receive the customer identification information, the processor determining the conference call information based on the customer identification information, the processor further coupled to the display to provide the conference call information to the customer.

2. The kiosk of claim 1, wherein the processor further determines a mobile telephone number of the mobile device and displays the mobile telephone number to the customer as the portion of the conference call information.

3. The kiosk of claim 2, further comprising:
a network interface coupled to the processor and to a network for enabling the processor to communicate with a kiosk server to instruct the kiosk server to establish the conference call.

4. The kiosk of claim 2, further comprising:
a graphical user interface enabling the customer to confirm or enter the mobile telephone number of the mobile device.

5. The kiosk of claim 4, wherein the graphical user interface includes a touchscreen on the display.

6. The kiosk of claim 1, wherein the display further displays a conference call icon that when selected by the customer establishes the conference call.

7. The kiosk of claim 6, wherein the conference call icon includes two or more icons, each for enabling the conference call to be established with a different agent of the call center or different call centers.

8. The kiosk of claim 1, wherein the conference call information displayed on the display includes a call center telephone number of the call center that the customer dials from the mobile device, the call center telephone number being viable for a limited duration of time.

9. The kiosk of claim 8, wherein the call center telephone number includes an access code that expires at the end of the limited duration of time.

10. The kiosk of claim 1, wherein the input device includes one or more of a touchscreen on the display, a barcode reader, a magnetic stripe reader, a keyboard, a keypad and a near field communication reader.

11. The kiosk of claim 1, wherein the kiosk is an automated teller machine (ATM), automated ticket machine or an airport kiosk.

12. A kiosk server in communication with a plurality of kiosks of a business, the kiosk server comprising:
a network interface for receiving, via a network, customer identification information identifying a customer of the business from a kiosk of the plurality of kiosks;
a processor for determining conference call information based on the customer identification information, the conference call information enabling a conference call to be established between a mobile device of the customer and an agent of a call center of the business.

13. The kiosk server of claim 12, wherein the conference call information includes a mobile telephone number of the mobile device and a call center telephone number of the call center, the processor further providing the mobile telephone number to the kiosk for display thereon and preventing the call center number from being provided to the kiosk for display thereon.

14. The kiosk server of claim 13, wherein the processor further provides the mobile telephone number and the call center telephone number to a conference bridge via the network interface to establish the conference call between the mobile device and the agent.

15. The kiosk server of claim 12, wherein the processor uses the customer identification information to retrieve customer data from an external database via the network interface and determines the conference call information from at least the customer data, the customer data including the mobile telephone number.

16. The kiosk server of claim 12, wherein the conference call information includes a call center telephone number of the call center that the customer dials from the mobile device, the call center telephone number being viable for a limited duration of time, the processor providing the call center telephone number to the kiosk via the network interface for display thereon to the customer.

17. A system, comprising:
a kiosk server associated with a business, the kiosk server for receiving, from a customer of the business via a kiosk communicatively coupled to the kiosk server, customer identification information that identifies the customer and determining conference call information based on the customer identification information, the conference call information including a mobile telephone number of a mobile device of the customer and a call center telephone number of a call center of the business;
a conference bridge coupled to the kiosk server via a network for receiving the conference call information and establishing a conference call between the mobile device of the customer and the call center; and
a call routing system within the call center for determining an agent for the conference call and routing the conference call to the agent.

18. The system of claim 17, wherein the conference bridge sets up a first leg of the conference call with the mobile device and subsequently sets up a second leg of the conference call with the call center.

19. The system of claim 17, wherein the call routing system further queries the kiosk server for call information related to at least one of the customer and the kiosk to determine the agent for the conference call, and wherein the kiosk server further determines customer data from the customer identification information, the call information including at least a portion of the customer data.

20. A method for voice-enabling a kiosk of a business with a mobile device, the method comprising:
receiving at a kiosk server communicatively coupled to the kiosk, from a customer of the business via the kiosk, customer identification information that identifies the customer;
determining, by the kiosk server, conference call information based on the customer identification information, the conference call information including a mobile telephone number of a mobile device of the customer and a call center telephone number of a call center of the business;
providing the conference call information from the kiosk server to a conference bridge via a network;
establishing, by the conference bridge, a conference call between the mobile device of the customer and the call center; and
routing, by the call center, the conference call to an appropriate agent.
